(19) United States
(12) Patent Application Publication
(10) Pub. No.: US 2008/0255919 A1
(43) Pub. Date: Oct. 16, 2008

(54) SYSTEM AND METHOD FOR SCHEDULE NOTIFICATION

(76) Inventor: Douglas P. Gorder, Sammamish, WA (US)

Correspondence Address: STOEL RIVES LLP - SLC, 201 SOUTH MAIN STREET, ONE UTAH CENTER, SALT LAKE CITY, UT, 84111, US

(21) Appl. No.: 12/100,559

(22) Filed: Apr. 10, 2008

Related U.S. Application Data
(60) Provisional application No. 60/910,890, filed on Apr. 10, 2007.

(51) Int. Cl. G06Q 10/00

(52) U.S. Cl. 705/9

(57) ABSTRACT

Systems and methods are provided for receiving schedule information and providing notifications to participants of the schedule and scheduled jobs or tasks. Employees may define preferences for the content, mode, and timing of notifications. Notifications may be sent via text message, including SMS and IM text messages, and also via email, telephone call, pager, and fax. Employees may be enabled to respond to text message notifications either confirming or rejecting scheduled jobs or tasks. Attendance of employees at scheduled jobs or tasks may also be tracked by receiving text messages or GPS information from the employees' cell phones. System and methods are also provided for sequentially notifying other employees, in order of employee priority, of opportunities to cover for employees who are unable to fill assigned jobs or tasks.

### CROSS-REFERENCE TO RELATED APPLICATIONS

This application claims priority to U.S. Provisional Patent Application No. 60/910,890, filed Apr. 10, 2007, which is hereby incorporated by reference.

### TECHNICAL FIELD

The present disclosure relates generally to techniques for notifying employees about work schedules.

### BRIEF DESCRIPTION OF THE DRAWINGS

FIG. 1 is a flow diagram of one embodiment of an employee scheduling and notification system.

FIG. 2 depicts one embodiment of notification interface of a schedule notification system.

FIG. 3 is block diagram of one embodiment of a schedule notification system and the components thereof.

FIG. 4 is a flow chart of one embodiment of a method for schedule notification.

FIG. 5 is a flow chart of another embodiment of a method for schedule notification.

FIG. 6 is a flow chart of a method for schedule notification adapted to systematically resolve schedule conflicts.

FIGS. 7A-7C are flow charts including optional steps that may be performed in the embodiments depicted in FIGS. 5 and 6.

FIG. 8 depicts an employee cell phone receiving a text message notification and importing scheduling information from the text message notification directly into a calendar or planner application on the phone.

### DETAILED DESCRIPTION

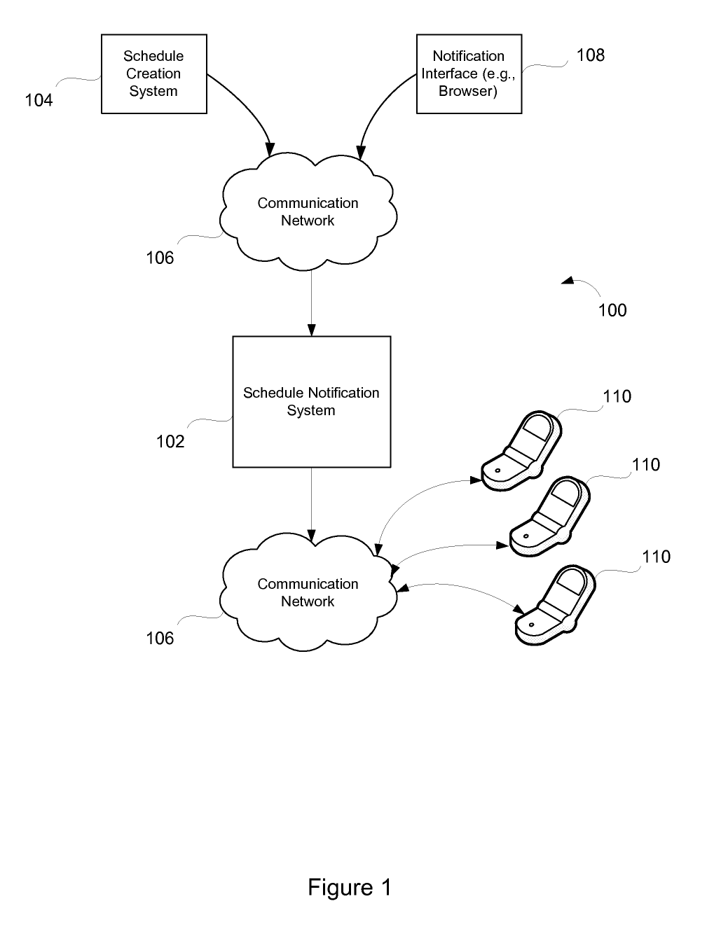

FIG. 1 is a high-level data flow diagram of an employee scheduling and notification system 100 according to an embodiment of the present disclosure. The system 100 may receive and/or access schedule information and employee-defined notification preferences to generate and send notifications to be communicated to employees scheduled for jobs or tasks. The employee scheduling and notification system 100 may include a schedule notification system 102 to receive schedule information from a schedule creation system 104. The schedule creation system 104 may include an enterprise software program for generating employee schedules for a large number of employees. Various schedule creation systems 104 are known in the art, such as Time Tracker 5.1, available from Asgard Systems, Inc. However, an artisan will recognize that other sources of schedule information are available.

The schedule creation system 104 may be separate from the schedule notification system 102 (as depicted), such that the schedule information is received via a communication network 106. In another embodiment, the schedule creation system 104 may be integrated with the schedule notification system 102. In still another embodiment, a user may directly enter schedule information into schedule notification system 102.

The employee scheduling and notification system 100 may further include a notification interface 108 to enable employees and/or administrators to interface with the schedule notification system 102. The notification interface 108 may comprise a web page accessible via the World Wide Web or the Internet, and may communicate with the schedule notification system 102 via the network 106. As described in greater detail hereafter, employees may be enabled to define employee preferences for the content, mode, and timing of notifications to be sent to the employee providing information relating to scheduled jobs or tasks the employee is scheduled to perform. Examples of content preferences may include, but are not limited to, choosing to be notified of the date, start time, stop time, estimated duration, location, on-site contact person, supervisor, rate of pay for a scheduled job or task, whether a scheduled job or task is considered overtime, job or task description, and instructions for responding to the notification to confirm or decline the scheduled job or task.

The employee scheduling and notification system 100 may communicate with employees primarily by mode of text message notifications. Text message notifications may comprise, for example, Short Message Service (SMS) text messages or Instant Messenger (IM) text messages. However, employees may define preferences for other modes of receiving notifications. Examples of mode preferences to specify the mode of receiving notifications may include, but are not limited to, SMS text message, IM text message, email, voice mail, voice telephone call, pager, and fax.

Employees may also define preferences to specify when the employee scheduling and notification system 100 should send notifications. Examples of timing preferences to specify when notifications will be sent to an employee may include, but are not limited to, immediately after a schedule is available, when a schedule period begins, a period of time in advance of a scheduled job or task (e.g. 15 minutes, a day, an hour, or other period), at a specified time every day (week, month, or other period), anytime except during a specified period of time (e.g. weekends, between 11:00 pm and 7:00 am), or all or any combination of the above. Employees could also choose to have the system continue to send notifications at some employee-chosen interval until receipt is acknowledged by the employee. Employees may also be enabled to define preferences for where the text message notifications should be sent. In one embodiment, multiple destinations may be designated.

In another embodiment, the notification interface 108 may further enable employees to schedule jobs or tasks and/or interface with the schedule creation system 104. Employees may be able to enter information concerning a scheduled job or task, including but not limited to a description, date, time, location, and/or participants and thereby create a scheduled job or task. In another embodiment, the notification interface 108 may maintain a master schedule and update it as schedule changes occur, further communicating the updated schedule information to the schedule notification system 102 as necessary. In still another embodiment, the notification interface 108 may simply communicate scheduled job or task information to a separate scheduling or calendaring system.

Administrators may also be enabled to perform administrative tasks and/or actions via the notification interface 108, such as uploading schedule information to the schedule notification system 102. In another embodiment, administrators may be enabled, via the notification interface 108, to override employee preferences relating to content, mode, and timing for generating and sending notifications.

In another embodiment, the notification interface 108 may be displayed on a cell phone or other handheld electronic device capable of sending and receiving text messages. The notification interface 108 may be a software application running on the handheld electronic device. In another embodiment, employees may generate and send text messages to interface with the employee scheduling and notification system 100. Employees may generate and send text messages containing pre-defined commands, fields, tags, or other indications of actions for the employee scheduling and notification system 100 to perform. Thus, employees may be enabled to define, via text message, preferences for schedule notifications sent to them, including but not limited to content and timing preferences.

The schedule notification system 102 may use schedule information and notification preferences to generate text message notifications relating to the employees' schedules. The schedule notification system 102 may receive schedule information, which may include one or more scheduled jobs or tasks, as well as an indication of the participants of each scheduled job or task. The participants for each scheduled job or task may be from a group of employees who have defined notification preferences. The schedule notification system 102 may generate a personalized text message for each employee. The text message may include information concerning a plurality of scheduled jobs or tasks, such as a daily, weekly or monthly schedule, or a schedule for some other period of time. A text message notification may also include information concerning a single scheduled job or task. The text message notification may be a reminder of a specific scheduled job or task, wherein the timing, mode, and content of the reminder is determined by the employee-defined preferences.

After generating the text message notification, the schedule notification system 102 may then send the text message notification to the intended recipients' cell phone 110, or to another electronic device capable of receiving text messages. Transmission of the text message notification may be via the communication network 106. Because text message notifications may be SMS text messages or IM text messages, the device to which the text message notifications are sent should be capable of receiving the designated type of text message.

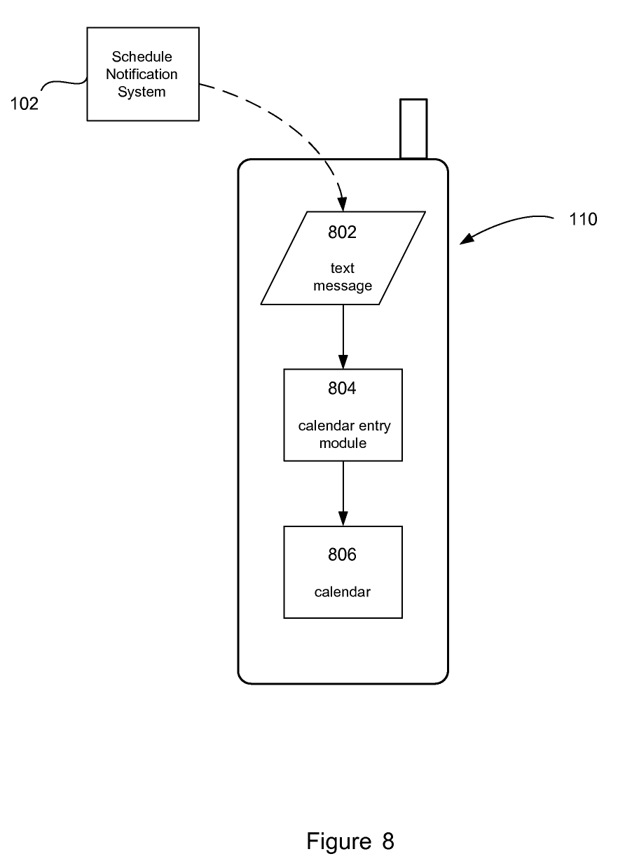

In another embodiment, the recipients' cell phone 110 may directly import schedule information into the calendar or planner application on the phone. As discussed in greater detail below in connection with FIG. 8, a client-side application on the cell phone may process a text message notification and import the information to the calendar or planner application. Automatically importing the information to create the scheduled event in the cell phone application may be accomplished by the application on the cell phone and signaled by tags, markup language, a sequence of characters, and/or the identity of the sender.

In another embodiment, the schedule notification system 102 may further include a calendaring or planner module (not shown) to keep track of scheduled jobs or tasks, and thus may be capable of maintaining a master schedule of all scheduled jobs or tasks. A master schedule and/or calendar may be maintained for a group of employees, such that multiple groups of employees may have separate master schedules and/or calendars. In another embodiment, the schedule notification system 102 may maintain a master schedule and/or calendar for all employees.

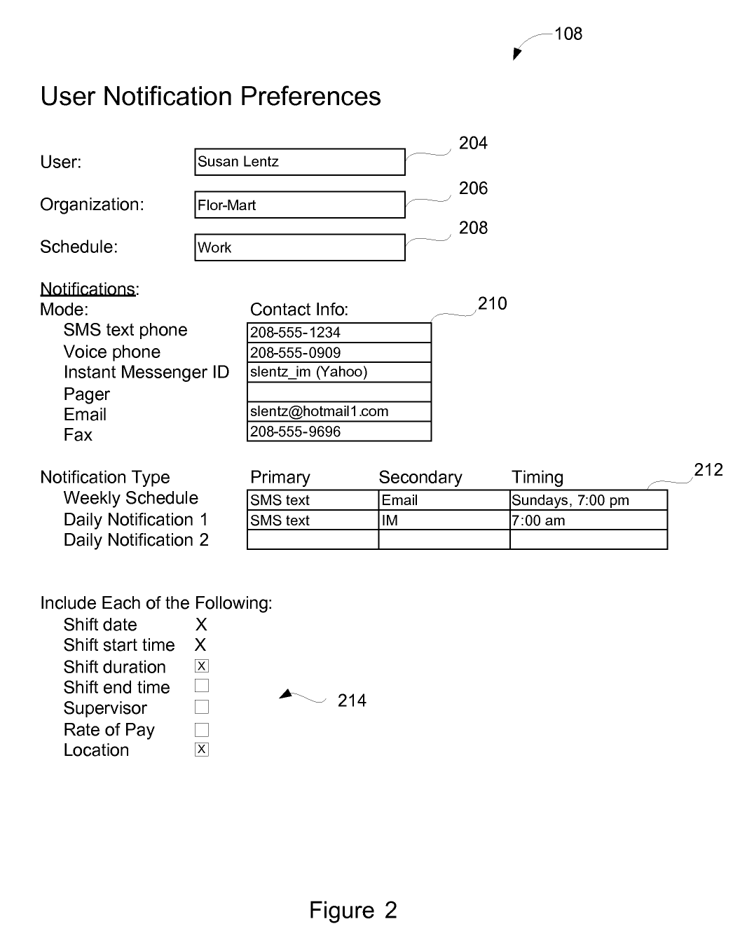

FIG. 2 depicts a notification interface 108 of a system for schedule notification according to one embodiment. The notification interface 108 may include various fields in which employees may define preferences. It will be appreciated by a person of ordinary skill in the art that any number of fields may be available for an employee to enter identifying and/or other information that can then be used by the system to generate text message notifications. The fields may be text fields that may be defined by allowing the employee to enter text, or fields may comprise a drop-down list of a series of pre-defined values. Check boxes and/or radio buttons may also be used. Moreover, certain fields may be automatically defined on behalf of the employee by the system, an administrator, and/or a supervisor. In another embodiment, the employee may be allowed to define a field's value, but one or more fields may be designated as ‘required’ such that the preferences (or changes thereto) are only saved if all required fields are defined.

One example of a field that may be defined by various sources is an employee field. As illustrated, one embodiment may enable the employee to enter his or her name in the employee field 204. The name could be changed as desired, however it may also be a required field. In another embodiment, the employee may only be allowed to enter a name at the time a record for the employee is created. In still another embodiment, an administrator may define the employee's name at the time a record for the employee is created, thus ensuring appropriate identifying information is associated with each employee. Ensuring appropriate identifying information may assist the employer in, among other things, identifying registered employees, monitoring which employees make use of the system, and tracking which employees are receiving text message notifications. An employee ID field may also be used as an identifier, and pre-set by either the system or an administrator.

The notification interface 108 may also include an organization field 206, in which an employee may enter the name of a company, such as an employer, or other organization associated with the schedule information. A schedule field 208 may enable an employee to designate a particular schedule type or simply designate the name of a particular schedule. Examples include, but are not limited to, a training schedule, supervisor schedule, manager schedule, cashier schedule, sales associate schedule, staff meeting schedule, etc. By combining the organization field and the schedule field, a system for schedule notification may be able to associate an employee with a group of employees and/or a particular schedule. In another embodiment, the company field 206 and the schedule field 208 may be defined on behalf of the employee, by an administrator. In still another embodiment, a single field may be used to associate the employee with a group of employees and/or a particular schedule, and this field may or may not be defined by the employee.

The notification interface 108 may further include notification mode fields 210 to define various modes by which an employee may receive notifications, and also notification type fields 212 by which an employee can designate different types of notifications to be sent. The notification mode fields 210 may include, but are not limited to, SMS text phone, voice phone, IM identifier, pager, email, and fax. The employee may provide, in the appropriate field, a unique identifier or address for that particular mode of receiving notifications. The schedule notification system may be programmed to use the unique identifier to transmit a schedule notification of the corresponding type. For example, the schedule notification system will use the combination of characters in the SMS text phone field to send an SMS text message notification. The fields may be programmed to only accept appropriate character combinations. For example, the fax field may be programmed to only accept combinations of seven or ten numbers, and to reject combinations containing letters.

The notification type fields 212 may include, but are not limited to, a weekly schedule notification, a first daily notification, and a second daily notification. Moreover, there may be a field for designating a primary mode for sending the particular notification type, as well as a secondary mode. The mode may be one of the modes provided for by the mode fields 210. For example, a first daily notification may be sent by mode of SMS text message, IM text message, email, voice mail, voice telephone call, pager, and fax. In another embodiment, any of the modes of communication may be specified as a primary notification mode or a secondary notification mode. A secondary notification mode may be a supplementary notification, to be sent in addition to the primary notification mode. In another embodiment, a secondary notification mode may be a mode of sending a secondary notification in the event the primary notification mode is not available, or not able to be sent or received. For example, a primary notification may fail if a network connection is lost or a phone line is busy, in which case a secondary notification may be sent via the mode designated.

There may also be a field to designate the timing of each notification type. Examples of timing preferences may include, but are not limited to, immediately after a schedule is available, when a schedule period begins, a period of time in advance of a scheduled job or task (e.g. 15 minutes, a day, an hour, or other period), at a specified time every day (week, month, or other period), anytime except a specified period of time (e.g. weekends, between 11:00 pm and 7:00 am), or all or any combination of the above.

An employee may enter the desired notification mode in the appropriate field for the desired type of notification, and then set a timing preference. For example, as depicted in FIG. 2, a weekly notification will be sent via the primary mode of SMS text, and also via a secondary mode of email. As depicted in FIG. 2, the weekly notifications will be sent on Sundays at 7:00 pm. A daily notification will be sent via a primary mode of SMS text, and also via a secondary mode of IM text. The first daily notifications will be sent at 7:00 am. No second daily notifications are designated. In another embodiment, a timing field may be available for both the primary and secondary modes for each notification type.

Depending on the type or purpose of the schedule, other notification types may be appropriate. For example, nurses and other medical support staff, waiters and waitresses, construction workers, and maintenance crews are often scheduled for several weeks or months at a time. In such cases a shift period schedule notification may be sent when a schedule for the shift period is first established or becomes available, and then subsequently when the shift period begins. A reminder notification about the shift schedule may also be sent in the middle of the shift period. In other cases, an employee may desire to receive a notification to be reminded of an upcoming scheduled job or task. For example, an employee with a widely varying work schedule may wish to be reminded one hour before each assigned shift.

The notification interface 108 may further include content preference fields 214, which enable the employee to designate the content to be received in each notification. By way of example, and not limitation, content preference fields may include date, start time, stop time, duration or estimated duration, on-site contact person, supervisor or manager, a rate of pay, and the location of the job or task. Other exemplary fields, not depicted in FIG. 2, may include a description of the job or task, whether the job or task is optional or required, and instructions for responding to the text message notification. As depicted in FIG. 2, some of the content preference fields, such as the shift date and shift start time, may be required and/or automatically included in all notifications, and thus not defined by the employee.

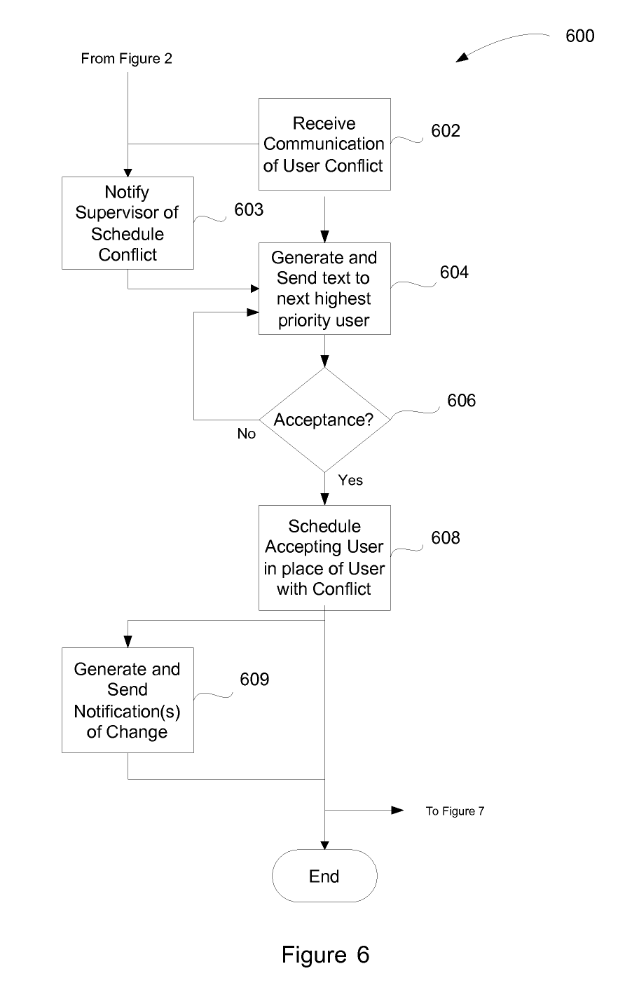

The notification interface 108 may also further include fields for defining preferences relating to receiving notifications of opportunities to replace, “fill-in,” or cover for, an employee assigned to participate in a scheduled job or task and unable to participate due to illness, schedule conflict, or other reason. Notifying other employees of opportunities to cover for employees with schedule conflicts is discussed below in conjunction with FIG. 6. Preferences relating to opportunities to cover the jobs or tasks scheduled for other users may include specifying times and/or days of the week, shift blocks, and/or types of scheduled jobs or tasks for which the employee would like to receive notice. In another embodiment, the employee may designate times, days, or types of jobs or tasks for which the employee does not want to receive notice.

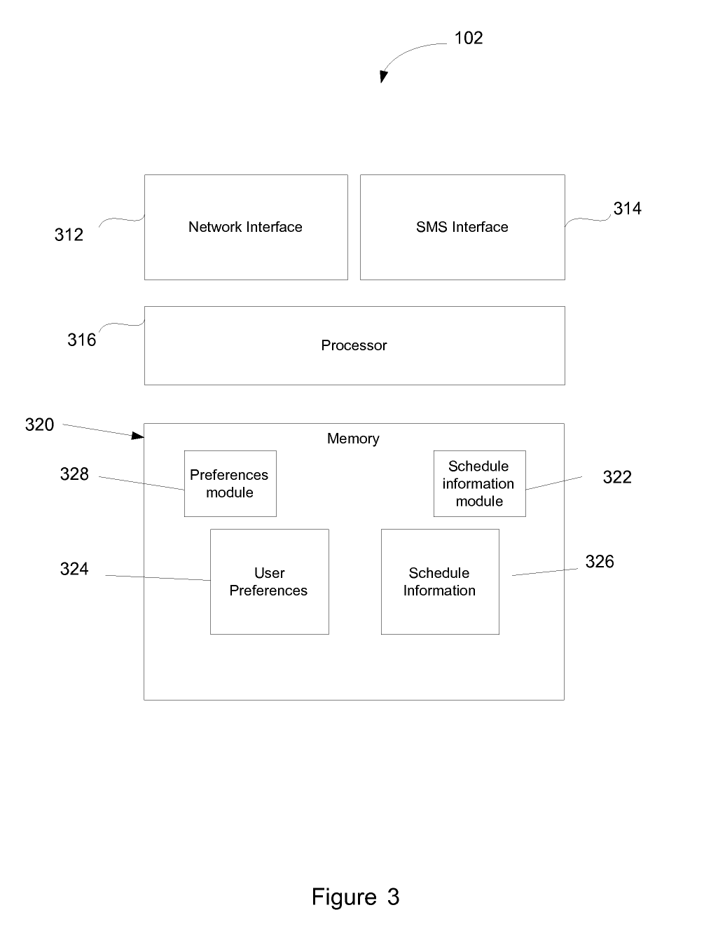

FIG. 3 is a block diagram showing additional details of the schedule notification system 102 according to one embodiment. The schedule notification system 102 may include a processor 316 coupled to a memory 320. The processor 316 may comprise a microchip or similar computer processor. The processor 316 may process schedule information and employee-defined preferences stored in the memory 320 to generate text message notifications concerning schedule information to send to employees. The processor 316 may also process information for determining employee priority for covering for other employees who may be unable to attend one or more jobs or tasks for which they were scheduled, as discussed in greater detail below in connection with FIG. 6.

The memory 320 may store the employee-defined notification preferences 324 and schedule information 326. The memory 320 may also store a preferences module 328 to receive and store the notification preferences, as well as a schedule information module 322 to receive and store the schedule information concerning one or more scheduled jobs or tasks and the employees scheduled to participate in the scheduled jobs or tasks. In another embodiment, memory 320 may also store program instructions to direct the processor 316 to generate the text message notifications to send to employees.

The schedule notification system 102 may further include a network interface module 312 to facilitate communicating, via a communication network, with a schedule creation system (see FIG. 1). Network interface module 312 may also facilitate communications via Instant Messenger (IM) by enabling access to the Internet and/or the World Wide Web, so as to access IM services.

The schedule notification system 102 may also include an SMS interface 314 to facilitate sending text message notifications via SMS text. Moreover, the SMS interface 314 may facilitate receiving SMS text responses from employees. As discussed below, in connection with FIG. 6, employees may be asked to respond to text message notifications to confirm acceptance of a schedule and/or scheduled job or task. Employees may also be asked to respond to text message notifications that invite the employee to cover for an employee scheduled to participate in a scheduled job or task, but have a conflict with the scheduled job or task. The SMS interface 314 may receive and process employee responses.

As noted above, the schedule notification system 102 may further include a calendaring module (not depicted) and/or planner module (not depicted) to maintain a master schedule for a group of employees. The master schedule may initially be received from a schedule creation system, or may be generated by the calendaring module and/or planner module. These modules may update and maintain the master schedule, performing tasks, such as, but not limited to, noting changes, scheduling replacements when employees have conflicts, and altering the schedule to accommodate for delays or other unanticipated changes.

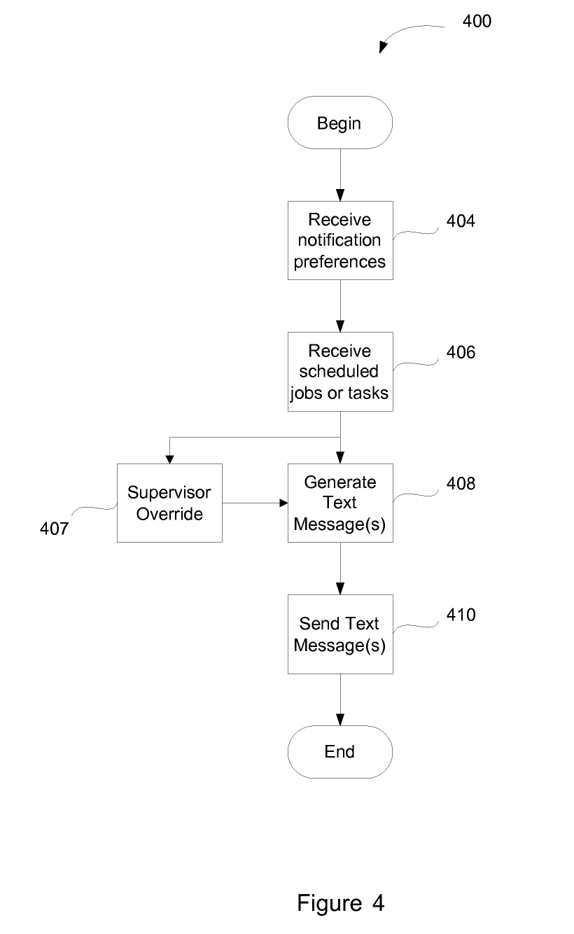

FIG. 4 shows a flow chart of one embodiment of a method 400 for schedule notification. The method 400 may begin by receiving 404 employee-defined notification preferences from an employee. The preferences may be received directly, or may be received via a notification interface. The method 400 may further receive 406 schedule information. The schedule information may include one or more scheduled jobs or tasks making up a schedule. The method 400 may then generate 408 text message notifications to be sent to the cell phone of each employee by processing the schedule information and the notification preferences.

Optionally, the method 400 may include a step in which a supervisor overrides 407 the employee notification preferences to determine the content and/or timing of a text message notification to one or more employees. For example, a schedule change may result in employees being moved to different work locations than may be typical. The supervisor may require that a notification be sent containing location information for the scheduled jobs or tasks. Upon generating 408 the text message notifications, the method 400 may then send 410 the text message notifications to the intended employees. A person having ordinary skill in the art will appreciate that the method may generate a text message notification and then send it before generating another text message notification, repeating the process until messages are generated and sent.

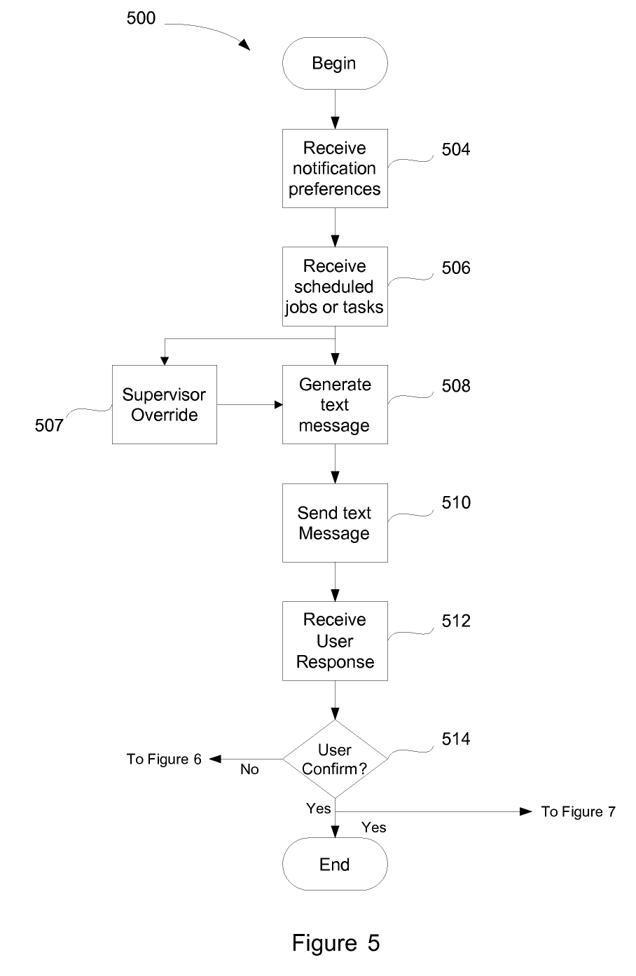

FIG. 5 shows a flow chart of another embodiment of a method 500 for schedule notification. As with the method of FIG. 4, the method 500 may begin by receiving 504 employee-defined preferences from an employee, receiving 506 scheduled job or task information, generating 508 text message notifications based on scheduled jobs or tasks and employee preferences, optionally allowing a supervisor to override 507 the employee preferences, and sending 510 the text message notifications to the intended employees. The method 500 may further receive 512 a response from an employee and then determining 514 from the response if the employee confirms the schedule or a particular scheduled job or task.

To determine whether or not the responding employee has confirmed the schedule or scheduled job or task, the method 500 may search for one or more key terms, patterns, commands, including but not limited to “yes,” “no,” “confirm,” “accept,” “decline,” or “conflict.” Employees may be instructed in the text message how to respond.

In another embodiment, the method 500 may receive 512 a response indicating that the employee received the notification. Such a response may be requested in a text message notification, automatically processed by the employee's cell phone or other text device, and then automatically generated and sent when the employee reads (or views) the text message. An employee may be able to define via the notification interface a preference specifying whether requests for automatic responses should be sent.

If the employee does not confirm the schedule or scheduled job or task, the method 500 may go to a separate process for handling schedule conflicts and finding a replacement to cover for the employee. One embodiment of this process is discussed below in connection with FIG. 6. An employee may decline or reject a schedule or scheduled job or task by sending a negative response as instructed in the text notification. In another embodiment, a failure to respond affirmatively within a specified period of time may result in a default negative response.

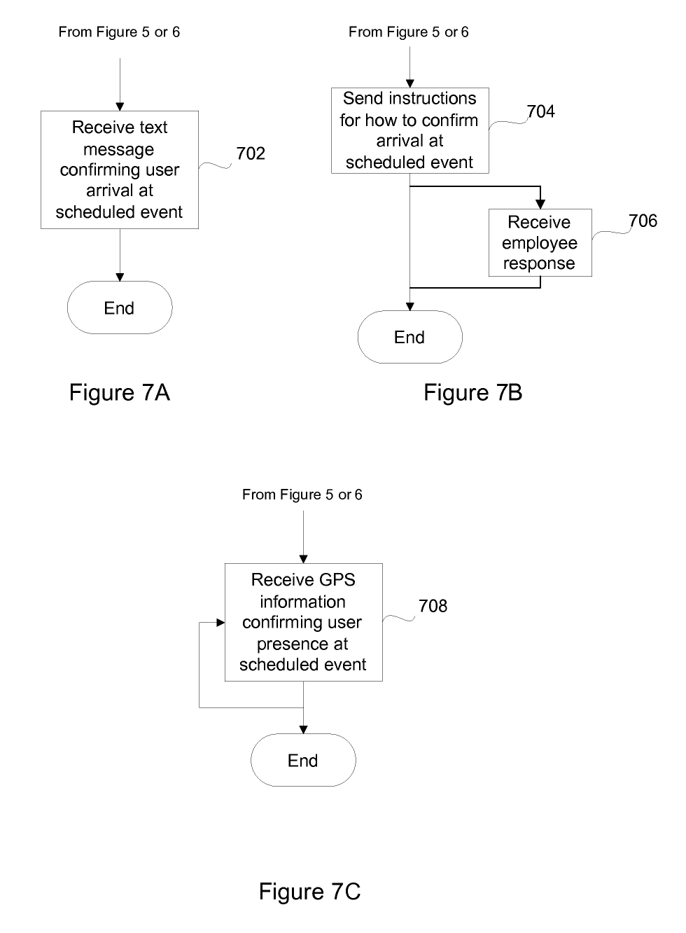

Alternatively, if the employee does confirm the schedule or scheduled job or task, the method may end. In another embodiment, an affirmative response may result in additional steps of the routine, such as steps for confirming that the employee attends the one or more scheduled jobs or tasks for which the employee is scheduled to participate, as discussed below in connection with FIG. 7.

FIG. 6 shows a flow chart of a method 600 for schedule notification adapted to systematically resolve schedule conflicts. The method 600 may begin when an employee does not confirm a schedule or scheduled job or task as requested in a text message notification. Alternatively, method 600 may begin upon receiving 602 a notification of an employee conflict. For example, after accepting a shift assignment, an employee may call a supervisor and indicate that he or she is ill, such that the employee can no longer be at the assigned work shift. Also, rather than calling the supervisor, the employee also could send a text message to the supervisor. The supervisor may then communicate the conflict to begin method 600.

The method 600 may include a step of notifying 603 the supervisor of the schedule conflict. If the employee responds to a text message notification by declining a schedule or scheduled task, a supervisor may not be aware of, and may have no way to become aware of, the schedule conflict. This step may enable a supervisor to monitor which employees are not fulfilling their assigned shifts, and also alerts the supervisor that there may be a gap in the schedule if the shift is not covered by another employee.

With notice of an employee conflict, method 600 may proceed to perform a priority notification process. This may be accomplished by generating and sending 604 a text message notification to the next highest priority employee among a group of priority employees who are available and/or qualified to cover for the employee with the conflict. Priority of employees may be determined a variety of ways, including but not limited to, seniority, alphabetically, or an ordered list such that all employees have a turn having the highest priority. Moreover, other factors may be considered in determining employee priority, including but not limited to, skill level, location, availability to fill the open shift, and/or shift preference. Priority may be determined by a schedule creation system. In another embodiment, priority may be determined by the employee scheduling and notification system. When the highest priority employee is identified, a text message notification is generated and sent based on the employee-defined notification preferences of the highest priority employee, thereby notifying that employee of the opportunity to cover the shift now available due to the conflict.

The method 600 may wait a specified period of time for the shift to be accepted 606 by the highest priority employee. The highest priority employee may accept, decline, or not respond. If the employee declines, or if no response is received after a specified amount of time, then the next highest priority employee is determined and a message is generated and sent 604 to that next highest priority employee. This process of sending text message notifications sequentially to all employees in the priority group in order of priority, and awaiting a response from each may continue until an acceptance is received or until all employees in the priority group have declined the opportunity to fill the shift. If no employee accepts the shift, a text message notification may be generated and sent to the supervisor. In another embodiment, the employee with the lowest priority may be forced to accept the shift.

Once an acceptance 606 is received, the accepting employee is scheduled 608 in place of the employee with the conflict. The change may be scheduled in an internal calendaring and/or planner system that may maintain a master schedule for the group. In another embodiment, the change may be communicated back to a schedule creation system that initially created the schedule and that maintains a master schedule. In still another embodiment, the change may be communicated back to the creator of the scheduled job or task.

Optionally, method 600 may generate and send 609 text message notifications of the schedule change. A supervisor may be sent 609 a notification that the schedule was changed. The employee with the conflict may also be sent 609 a notification that the shift has been covered. Finally, the employee covering the shift may also be sent 609 a notification confirming that he or she is now assigned to the shift.

FIGS. 7A-7C depict optional additional steps to methods 500 and 600 of FIGS. 5 and 6 respectively. The additional steps may assist in tracking employee attendance at scheduled jobs or tasks. Specifically, FIG. 7A depicts an additional step of receiving 702 a text message confirming the employee's arrival at the scheduled job or task. After the employee confirms that he or she will participate in a scheduled job or task, it may be useful to automatically determine if the employee actually participated. Employers may benefit from receiving a text message confirmation that the employee has arrived for his shift. The text message confirmation may be stored for confirmation purposes, or may be used as a primary means of tracking an employee's time in and time out. A variety of systems may be employed to ensure the employee actually arrives at the job or task. For example, a shift code could be displayed somewhere on the premises and employees may be required to send a text message containing the code. As another example, an employee may be required to obtain a shift code from a supervisor, thereby creating an incentive for employees to actually report to the supervisor, in addition to creating a record that the employee arrived to the scheduled shift.

FIG. 7B depicts another embodiment of an additional step that may be used to confirm employee attendance at a scheduled job or task. The method may send 704, via text message notification, instructions to the employee for how to confirm arrival at the scheduled job or task. The instructions may include providing a return text containing information assuring the employee arrived at the premises. Instructions may also include contacting a supervisor. Optionally, the method may also receive 706 the user response.

FIG. 7C depicts still another additional step that may be used to confirm that an employee participates in a scheduled job or task for which the employee is scheduled. Rather than relying on an employee to provide confirmation, the process can be further automated by receiving 708 global positioning system (GPS) information from the employee's cell phone. The employee and/or an administrator may be enabled to set a preference to include instructions to the phone, in each text message notification, to provide GPS information when the employee arrives at the job or task. The foregoing technique may provide information during the scheduled job or task to monitor whether the employee remains at the scheduled job or task. This additional step may be particularly useful for employers who are unable to constantly supervise employees and have employees often claiming they were at work when they were never near the job site during the assigned shift.

FIG. 8 depicts an employee cell phone 110 receiving a text message notification 802 and importing schedule information directly into a calendar or planner application on the phone, according to one embodiment. The text message notification 802 and/or schedule information may be formatted in a specified way, or include tags or markup language (e.g. XML), so as to be directly imported to the calendar or planner application. A calendar entry module 804 on the cell phone may receive and process a text message notification and import the information to a cell phone calendar 806. Importing the information to create a scheduled event in the cell phone calendar 806 may be accomplished by the calendar entry module. The calendar entry module 804 may be signaled and/or directed to import schedule information by tags, markup language, a sequence of characters, and/or the identity of the sender.

As depicted, cell phone 110 may receive from schedule notification system 102 a text message notification 802. The calendar entry module 804 may process schedule information transmitted in the text message notification 802 and create an entry in the calendar 806 on the cell phone. In one embodiment, the calendar entry module 804 may process scheduling information data transmitted in a text message notification, following commands and reformatting the data, and interfacing with the calendar 806 to create a calendar entry. For example, the calendar entry module 804 may strip out tags and/or markup language, or may reformat the data. In another embodiment, the calendar entry module 802 may be integrated with the calendar module 804. In still another embodiment, the calendar 806 may comprise a calendar or planner application running on a cell phone.

The above description provides numerous specific details for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps or by a combination of hardware, software, and/or firmware.

Embodiments may also be provided as a computer program product including a computer-readable medium having stored thereon instructions that may be used to program a computer (or other electronic device) to perform processes described herein. The computer-readable medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions.

As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, etc. that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

It will be understood by those having skill in the art that many changes may be made to the details of the above-described embodiments without departing from the underlying principles of the invention. The scope of the present invention should, therefore, be determined only by the following claims.

What is claimed is:

1. A method for notifying employees of their work schedules, the method comprising:
accessing one or more schedule notification preferences for each employee, the schedule notification preferences comprising at least one of the group consisting of timing preferences, mode preferences, and content preferences;
receiving a work schedule for each employee from a centralized schedule creation system; and
sending to a cell phone of each employee a text message notification of a respective work schedule in accordance with at least one specified schedule notification preference.

2. The method of claim 1, wherein at least one timing preference comprises a preference for one or more times of day at which the employee prefers to receive text message notifications.

3. The method of claim 1, wherein at least one timing preference comprises a preference for one or more days of the week in which the employee prefers to receive text message notifications.

4. The method of claim 1, wherein at least one timing preference comprises a preference for receiving text message notifications at one or more of the following times: immediately after a schedule is available, when a schedule period begins, a specified period of time in advance of a scheduled job or task, and at a specified time within a given time period.

5. The method of claim 1, wherein at least one timing preference comprises a preference to have notifications repeatedly sent at an employee-chosen interval until receipt is acknowledged.

6. The method of claim 1, wherein at least one mode preference comprises a preference for a Short Message Service (SMS) notification.

7. The method of claim 1, wherein at least one mode preference comprise a preference for an Instant Message (IM) notification.

8. The method of claim 1, wherein at least one mode preference comprises a preference for receiving a supplementary notification via one or more of the following modes of communication: email, voice mail, voice telephone call, pager, and fax.

9. The method of claim 1, wherein at least one content preference comprise a preference for whether to include one or more of the following details pertaining to a job or task within a text message notification: date, start time, stop time, estimated duration, location, on-site contact person, supervisor, rate of pay, category of pay, description, and instructions for responding to the text message notification to confirm or decline the job or task.

10. The method of claim 1, further comprising receiving from an employee a response to a notification via a text message, wherein the response indicates whether the employee accepts a scheduled job or task.

11. The method of claim 1, further comprising:
upon receiving communication that a first employee does not accept a scheduled job or task, sequentially sending a notification to a group of other employees until a second employee sends a response indicating that the second employee accepts the scheduled job or task.

12. The method of claim 11, wherein sequentially sending a notification to the group of other employees occurs in order of employee priority.

13. The method of claim 1, further comprising receiving from an employee a text message upon the employee arriving at a scheduled job or task to confirm the employee's attendance at the scheduled job or task.

14. The method of claim 1, further comprising receiving from the employee's cell phone Global Positioning System (GPS) information confirming the employee's presence at a location of a scheduled job or task.

15. An employee scheduling and notification system comprising:
a notification interface to enable an employee to define one or more schedule notification preferences, wherein the schedule notification preferences comprising at least one of the group consisting of timing preferences, mode preferences, and content preferences; and
a schedule notification system in communication with the notification interface, the schedule notification system comprising:
a computer readable storage medium to store employee preferences and schedule information;
a processor to send text message notification of a work schedule, wherein the processor processes schedule information for one or more scheduled jobs or tasks, including the employees scheduled to participate in the one or more scheduled jobs or tasks, and schedule notification preferences from each employee, and wherein the timing, mode, and content of the text message notification are based on at least one specified schedule notification preference;

16. The system of claim 15, further comprising a network interface to connect the scheduling and notification system with a communication network to enable the system to send text messages.

17. The system of claim 15, wherein the notification interface comprises a web application accessible from a personal computer.

18. The system of claim 15, wherein the notification interface comprises an application on a cell phone.

19. A system comprising:
a preferences module to receive and store schedule notification preferences relating to timing, mode, and content of notifications;
a schedule module to receive and store schedule information for one or more scheduled jobs or tasks and employees scheduled to participate in the one or more scheduled jobs or tasks; and
a processor to generate and send a text message notification of a scheduled job or task to an employee scheduled to participate in the scheduled job or task, wherein the timing, mode, and content of the notification is based on at last one specified schedule notification preference.

20. A method for notifying a group of employees of schedule information, the method comprising:
receiving schedule information for one or more scheduled jobs or tasks, wherein the schedule information includes employees scheduled to participate in each of the one or more scheduled jobs or tasks;
enabling an employee to define schedule notification preferences that specify at least one of mode, content, and timing of notifications sent to the employee; and
sending a text message notification relating to scheduled jobs or tasks to be sent to the employee's cell phone, the text message notification comprising schedule information relating to scheduled jobs or tasks for which the employee is scheduled to participate, wherein the notification is sent in accordance with at least one specified schedule notification preference.

21. The method of claim 20, wherein a supervisor can override at least one of the schedule notification preferences for generating and sending SMS text notifications of schedule information.

22. The method of claim 20, wherein a scheduled job or task comprises a location, date, and start time.

23. The method of claim 22, wherein a scheduled job or task further comprises at least one of an end time and duration.

24. A method of coordinating schedule changes via text message communication, the method comprising:
receiving a communication from a first employee indicating a conflict with a scheduled job or task;
sending notification to a group of other employees, sequentially and in order of employee priority, of an opportunity to participate in the scheduled job or task, wherein notifications are sent to each employee until a response is received from a second employee indicating acceptance of the scheduled job or task; and
scheduling the second employee in place of the first employee.

25. The method of claim 24, further comprising:
sending notifications of the schedule change to the first employee and the second employee according to schedule notification preferences relating to timing, mode and content.

26. The method of claim 24, further comprising sending a notification of the schedule change to a supervisor.
